(19) United States
(12) Patent Application Publication
(10) Pub. No.: US 2026/0120961 A1
(43) Pub. Date: Apr. 30, 2026

(54) TANTALUM CAPACITOR

(71) Applicant: SAMSUNG ELECTRO-MECHANICS CO., LTD., Suwon-si (KR)

(72) Inventors: Byung Kyu SEO, Suwon-si (KR); Woo Sung LEE, Suwon-si (KR); Hee Sung CHOI, Suwon-si (KR); Hyun Ho SHIN, Suwon-si (KR); Kyoung Hwan KIM, Suwon-si (KR); Yong Hyun LEE, Suwon-si (KR); Youn Soo KIM, Suwon-si (KR); Il Man KANG, Suwon-si (KR); Kwang Sup SHIM, Suwon-si (KR)

(73) Assignee: SAMSUNG ELECTRO-MECHANICS CO., LTD., Suwon-si (KR)

(21) Appl. No.: 18/986,433

(22) Filed: Dec. 18, 2024

(30) Foreign Application Priority Data
Dec. 29, 2023 (KR) 10-2023-0196012

(51) Int. Cl. H01G 9/06; H01G 9/012; H01G 9/042

(52) U.S. Cl. CPC H01G 9/06; H01G 9/012; H01G 9/042

(57) ABSTRACT

A tantalum capacitor is provided, comprising an insulating material with a recess portion having a bottom surface lower than the one surface of the insulating material. A tantalum body, including a tantalum element body formed from tantalum powder and a tantalum wire passing through at least a portion of the tantalum element body in a first direction, is disposed on the bottom surface. The capacitor also includes a molded portion formed around the tantalum body, having opposing first, second, third, fourth, fifth, and sixth surfaces along three orthogonal directions. First and second external electrodes are connected to the tantalum body and spaced apart from each other in the first direction.

### CROSS-REFERENCE TO RELATED APPLICATION(S)

This application claims benefit of priority to Korean Patent Application No. 10-2023-0196012 filed on Dec. 29, 2023 in the Korean Intellectual Property Office, the disclosure of which is incorporated herein by reference in its entirety.

### TECHNICAL FIELD

The present disclosure relates to a tantalum capacitor.

A tantalum (Ta) material is a metal widely used across industries, including the electrical and electronics, machinery, chemical engineering, medical, aerospace, and defense industries, due to mechanical and physical characteristics thereof, such as high melting point, excellent ductility and corrosion resistance.

In particular, tantalum has been widely used as an anode material for small-sized capacitors due to its characteristics which form the most stable anodized film, among all metals.

Moreover, the use of tantalum material has rapidly increased annually, due to the recent rapid development of IT industries, such as electronics, information and communication, and the like.

A tantalum capacitor may use an internal lead frame or a mounting sheet to connect a tantalum body and an electrode to each other, and may then form an epoxy molding compound (EMC) to complete the tantalum capacitor. In this case, an interface between the lead frame/mount sheet and the EMC may occur, and defects such as moisture permeation and cracks may occur depending on adhesion strength.

### SUMMARY

An aspect of the present disclosure provides a tantalum capacitor with excellent reliability by reinforcing an interface of the tantalum capacitor.

Another aspect of the present disclosure provides a tantalum capacitor including a tantalum body with excellent mounting precision and excellent connection reliability.

According to an aspect of the present disclosure, there is provided a tantalum capacitor comprising an insulating material having one surface in which a recess portion having a bottom surface lower than the one surface is formed, a tantalum body disposed on the bottom surface, the tantalum body including a tantalum element body, and a tantalum wire passing through at least a portion of the tantalum element body in a first direction. A molded portion, having a fifth surface and a sixth surface opposing each other in the first direction, a third surface and a fourth surface opposing each other in a second direction, a first surface and a second surface opposing each other in a third direction, the molded portion formed to surround the tantalum body. First and second external electrodes are connected to the tantalum body and spaced apart from each other in the first direction.

According to example embodiments of the present disclosure, a tantalum capacitor may have excellent reliability by reinforcing the interface of the tantalum capacitor.

According to example embodiments of the present disclosure, a tantalum capacitor may include a tantalum body with excellent mounting precision and excellent connection reliability.

### BRIEF DESCRIPTION OF DRAWINGS

The above and other aspects, features, and advantages of the present disclosure will be more clearly understood from the following detailed description, taken in conjunction with the accompanying drawings, wherein:

FIG. 1 is a perspective view of a tantalum capacitor, according to the present disclosure;

FIG. 2 is a diagram illustrating an insulating material of a tantalum capacitor, according to the present disclosure;

FIG. 3 is a diagram illustrating a tantalum capacitor viewed in a second direction, according to the present disclosure;

FIG. 4 is an enlarged view of portion “A”of FIG. 3;

FIG. 5 is a cross-sectional view taken along line I-I′ of FIG. 1; and

FIG. 6 is a diagram illustrating a tantalum capacitor viewed in a first direction, according to the present disclosure.

### DETAILED DESCRIPTION

Hereinafter, example embodiments of the present disclosure are described with reference to the accompanying drawings. The present disclosure may, however, be exemplified in many different forms and should not be construed as limited to the specific example embodiments set forth herein. In addition, example embodiments of the present disclosure are provided for a more complete description of the present disclosure to those skilled in the art. Accordingly, the shapes and sizes of the elements in the drawings may be exaggerated for clarity of description, and elements denoted by the same reference numerals in the drawings refer to the same elements.

Hereinafter, preferred example embodiments of the present disclosure are described with reference to the accompanying drawings.

In the drawings, an X-direction may be defined as a first direction, an L-direction, or a length direction, a Y-direction may be defined as a second direction, a W-direction, or a width direction, and a Z-direction may be defined as a third direction, a T-direction, or a thickness direction.

Here, the first direction (X-direction), the second direction (Y-direction), and the third direction (Z-direction) are perpendicular to each other. In the following description, each of the first direction (X-direction), the second direction (Y-direction), and the third direction (Z-direction) may represent both directions.

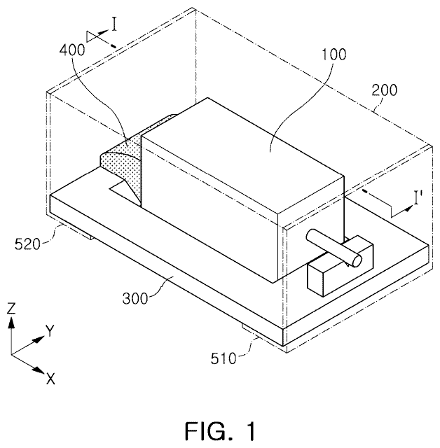

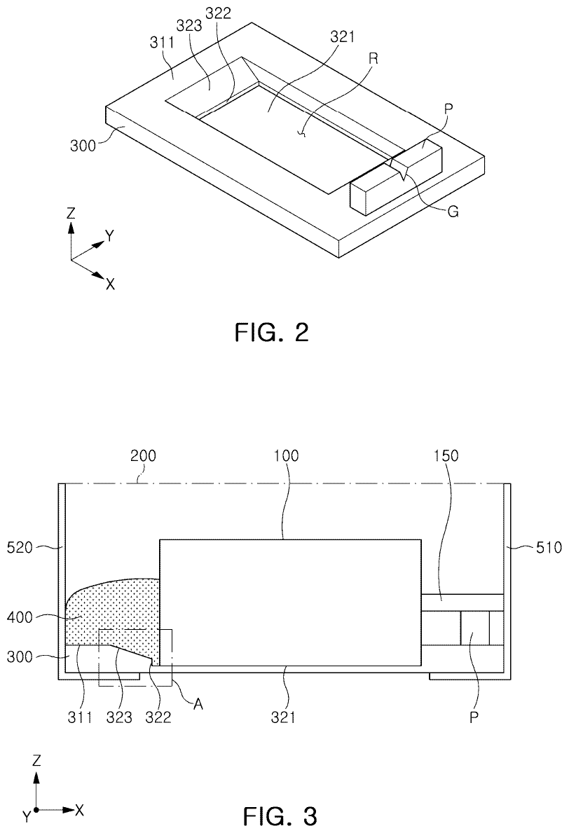

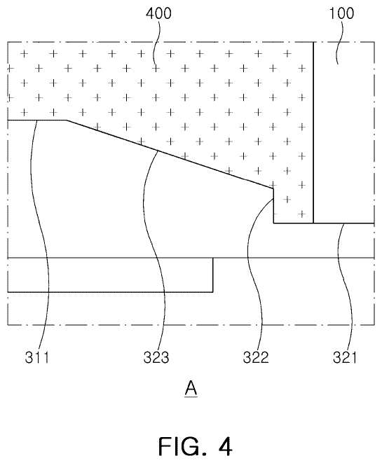

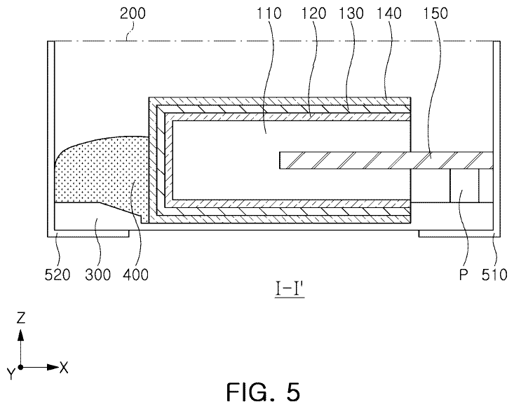

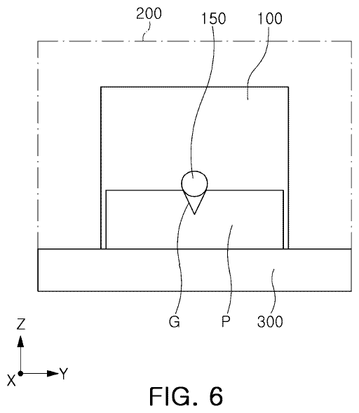

FIG. 1 is a perspective view of a tantalum capacitor according to the present disclosure. FIG. 2 is a diagram illustrating an insulating material of a tantalum capacitor, according to the present disclosure. FIG. 3 is a diagram illustrating a tantalum capacitor viewed in a second direction according to the present disclosure. FIG. 4 is an enlarged view of portion “A” of FIG. 3. FIG. 5 is a cross-sectional view taken along line I-I′ of FIG. 1. FIG. 6 is a diagram illustrating a tantalum capacitor viewed in a first direction according to the present disclosure.

Referring to FIGS. 1 and 2, a tantalum capacitor 1000, according to the present example embodiment may include a tantalum body 100, a molded portion 200, an insulating material 300, and external electrodes 510 and 520, and may further include a withdrawal layer 400.

The tantalum body 100 may include a tantalum element body 110 and a tantalum wire 150 passing through at least a portion of the tantalum element body in a first direction.

Here, the tantalum wire 150 may pass through at least a portion of the tantalum element body 110 in the first direction (X-direction). The tantalum wire 150 may be inserted into and installed in a mixture of tantalum powder and a binder to be offset before the mixture of the tantalum powder and the binder is compressed. That is, the tantalum body 100 may be manufactured by inserting the tantalum wire 150 in the tantalum powder mixed with the binder, forming a tantalum element of a desired size, and then sintering the tantalum element in a high temperature and high-vacuum (10⁻⁵ torr or less) atmosphere for about 30 minutes.

The tantalum body 100 may be disposed on a bottom surface of a recess portion R of the insulating material 300, as described below.

The molded portion 200 may be formed to surround the tantalum body 100 and may be disposed on one surface of the insulating material 300 as described below.

The molded portion 200 may have fifth and sixth surfaces opposing each other in the first direction (X-direction), third and fourth surfaces opposing each other in a second direction, and first and second surfaces opposing each other in a third direction.

The molded portion 200 of the tantalum capacitor according to the present disclosure may be formed by transfer-molding a resin, such as an epoxy molding compound (EMC) or the like, to surround the tantalum body 100. The molded portion 200 may protect the tantalum wire 150 and the tantalum body 100 from external elements.

The first and second external electrodes 510 and 520 are spaced apart in the first direction (X-direction) and are connected to the tantalum body 100. Specifically, the first and second external electrodes 510 and 520 may be disposed on the fifth and sixth surfaces of the molded portion 200.

The first external electrode 510 may be connected to the tantalum wire 150 to serve as a terminal when mounted on a board. The first external electrode 510 may function as anode of the tantalum capacitor 1000 according to the present disclosure.

The second external electrode 520 may be connected to the tantalum body 100 to serve as a terminal when mounted on a board. The second external electrode 520 may be connected to the tantalum body 100 through the withdrawal layer 400 as described below. The second external electrode 520 may function as cathode of the tantalum capacitor 1000 according to the present disclosure.

The first and second external electrodes 510 and 520 may extend to the other surface (a lower surface) of the insulating material 300 as described below. That is, the first external electrode 510 may extend from the fifth surface of the molded portion to the lower surface of the insulating material, and the second external electrode 520 may extend from the sixth surface of the molded portion to the other surface of the insulating material.

The first and second external electrodes 510 and 520 may include a metal with excellent electrical conductivity. Specifically, the first and second external electrodes 510 and 520 may be formed of a conductive metal including nickel (Ni), tin (Sn), copper (Cu), a chromium titanium intermetallic compound (Cr(Ti)), palladium (Pd), iron (Fe), and/or alloys thereof.

The first and second external electrodes 510 and 520 may be formed as a plating layer, and a plating method, such as a sputtering process, a subtractive process, an additive process, a semi-additive process (SAP), a modified semi-additive process (MSAP), or similar methods, may be used, but the present disclosure is not limited thereto. When the first and second external electrodes 510 and 520 are formed of a plating layer, a thin electrode having high density and low resistance may be formed.

FIG. 5 is a cross-sectional view taken along line I-I′ of FIG. 1.

Referring to FIG. 5, the tantalum body 100 of the tantalum capacitor 1000, according to an example embodiment of the present disclosure may include the tantalum element body 110 formed by sintering a molded body including metal powder, a conductive polymer layer 120 disposed on an upper portion of the tantalum element body 110, a carbon layer 130 disposed on the conductive polymer layer 120, and a silver (Ag) layer 140 disposed on the carbon layer 130.

The tantalum capacitor may further include the tantalum wire 150, having an insertion region positioned on the inside of the tantalum element body 110, and a non-insertion region positioned on the outside of the tantalum element body 110.

The tantalum element body 110 may be formed by sintering a molded body including metal powder and a binder.

Specifically, the tantalum element body 110 may be manufactured by mixing metal powder, a binder, and a solvent at a predetermined ratio, stirring the mixed powder, compressing the mixed powder to form a rectangular parallelepiped shape, and then sintering the same under high temperature and high vibrations.

The metal powder is not limited as long as it may be used in the tantalum element body 110 of the tantalum capacitor 1000, according to an example embodiment of the present disclosure, and may be tantalum (Ta) powder. However, the present disclosure is not limited thereto, and the metal powder may be one or more selected from the group consisting of aluminum (Al), niobium (Nb), vanadium (V), titanium (Ti), and zirconium (Zr). Accordingly, an aluminum element body, a niobium element body, or the like may also be used instead of a tantalum element body.

The binder is not limited, and may be, for example, a cellulose-based binder.

The cellulose-based binder may be one or more selected from the group consisting of nitrocellulose, methyl cellulose, ethyl cellulose, and hydroxy propyl cellulose.

In addition, the tantalum wire 150 may be inserted into and installed in the mixed powder to be offset before the mixed powder is compressed.

According to an example embodiment of the present disclosure, a dielectric oxide layer may be formed on the tantalum element body 110 as an insulating layer. That is, the dielectric oxide layer may be formed by growing an oxide film (Ta₂O₅) on a surface of the tantalum element body 110 through a formation process using an electrochemical reaction. Here, the dielectric oxide layer may change the tantalum element body 110 into a dielectric. In addition, the conductive polymer layer 120, having a negative polarity, may be coated and formed on the dielectric oxide layer.

The conductive polymer layer 120 is not limited and may include, for example, a conductive polymer.

Specifically, the conductive polymer may be formed using chemical polymerization or electrolytic polymerization of 3,4-ethylenedioxythiophene (EDOT), a pyrrole monomer, or polypyrrole, and may then be formed on an external surface of the tantalum element body 110, which is formed as an insulating layer, as a cathode layer having a conductive polymer cathode.

That is, the conductive polymer layer 120 may be formed using a polymer slurry, and the polymer slurry may include at least one of polypyrrole, polyaniline, or 3,4-ethylenedioxythiophene (EDOT). In addition, the conductive polymer layer 120 may include poly(3,4-ethylenedioxythiophene):poly(styrenesulfonate)(PEDOT: PSS). (PEDOT:PSS) may be prepared by oxidative polymerization of EDOT using polystyrene sulfonate (PSS) as a template for balancing an electric charge.

The carbon layer 130 may be laminated on the conductive polymer layer 120, and may be laminated by dissolving carbon powder in an organic solvent including an epoxy resin, impregnating the tantalum element body 110 in the solution in which the carbon powder is dissolved, and then perform drying thereon at a predetermined temperature to volatilize the organic solvent.

In addition, the carbon layer 130 may prevent silver (Ag) ions from passing through it.

Then, the silver (Ag) layer 140, formed of silver (Ag) paste, may be applied on an upper surface of the carbon layer 130.

The silver (Ag) layer 140 may be laminated on the outer surface of the carbon layer 130 to improve conductivity.

In addition, the silver (Ag) layer 140 may improve conductivity related to a polarity of a cathode layer, thereby facilitating electrical connection for polarity transfer.

The insulating material 300 of the tantalum capacitor 1000, according to the present disclosure will be described in detail with reference to FIGS. 2 and 3.

The insulating material 300 may have one surface 311 and the other surface opposing each other in the third direction (Z-direction). With reference to FIG. 2, the one surface 311 may refer to an upper surface of the insulating material 300, and the other surface may refer to a lower surface of the insulating material 300.

The insulating material 300 may include a recess portion R and a protrusion portion P on the one surface 311.

The recess portion R may be formed on the one surface 311 of the insulating material 300, and may have a bottom surface 321 lower than the one surface.

The tantalum body 100 may be disposed in the recess portion R, specifically on the bottom surface of the recess portion R. That is, the tantalum body 100 may be placed on the bottom surface 321, which is lower than the one surface 311, allowing for a more stable and precise mounting on the insulating material 300.

The lower surface of the tantalum body 100 may be lower than the one surface 311 of the insulating material, while the upper surface of the tantalum body 100 may extend higher than the one surface 311 of the insulating material.

The recess portion R may further include a side surface 322 that connects the one surface 311 of the insulating material to the bottom surface 321.

The side surface 322 of the recess portion R may be spaced apart from the tantalum body 100. In other words, the side surface 322 of the recess portion R does not contact the tantalum body 100, and a gap may be present between the side surface 322 of the recess portion R and the tantalum body 100. As will be described below, a portion of the withdrawal layer 400 may be disposed in the space. When metal paste is applied to one surface of the tantalum body 100 to form the withdrawal layer 400, the metal paste may enter part of the recess portion R, preventing the withdrawal layer 400 from overflowing unnecessarily, and ensuring uniform formation of the withdrawal layer 400.

The recess portion R may also have an inclined surface 323 connecting the one surface 311 of the insulating material to the bottom surface 321. The inclined surface 323 of the recess portion R may have an inclination angle relative to the one surface 311 of the insulating material.

The inclined surface 323 of the recess portion R may be spaced apart from the tantalum body 100.

The inclined surface of the recess portion R may have an inclination angle, increasing the mounting precision of the tantalum body 100. For example, in a vibration alignment method, the tantalum body 100 may slide down the inclined surface and be positioned on the bottom surface of the recess portion R.

The recess portion R may have both the side surface 322 and the inclined surface 323, but the present disclosure is not necessarily limited thereto, and may include only one of the side surface 322 and the inclined surface 323, and may not include any of the side surface 322 and the inclined surface 323.

The protrusion portion P may be formed on the one surface 311 of the insulating material 300 and protrude from the one surface 311.

The protrusion portion P may support the tantalum wire 150. Referring to FIG. 6, a groove G may be formed in an upper surface of the protrusion portion P, allowing it to support the tantalum wire 150 through the groove G, improving the position dispersion and stability of the tantalum wire 150.

The protrusion portion P may be spaced apart from the first and second external electrodes 510 and 520.

The insulating material 300 may be electrically insulated from the first and second external electrodes 510 and 520. Here, “insulation” refers to electrical insulation, meaning not only t preventing he flow of electricity (an approximately infinite electrical resistance value) but also having high electrical resistance compared to a surrounding components or conductors. In other words, the insulating material 300 is made of a material through which no current flows, and may mean electrical conductivity of, for example, 10⁻⁶ S/cm or less.

The insulating material 300 may include an epoxy resin, and specifically, may include an EMC. The insulating material 300 may include a material the same as that of the molded portion 200, and may be in the form of a sheet.

A tantalum capacitor according to the related art may use a lead frame or a mount sheet to fix a tantalum body 100, and then a molded portion 200 may be formed to complete the tantalum capacitor. In this case, an interface between a lead frame/mount sheet and an EMC may occur, and an interface may form between them, and defects such as moisture permeation and cracks may occur depending on adhesion strength.

Accordingly, in the tantalum capacitor 1000 according to the present disclosure, the molded portion 200 and the insulating material 300 may be formed of the same material to minimize the occurrence of an interface, thereby improving reliability.

However, the present disclosure is not limited thereto, and the insulating material 300 may include a thermosetting resin and a photocurable resin.

The tantalum capacitor 1000 according to an example embodiment of the present disclosure may further include the withdrawal layer 400.

The withdrawal layer 400 may be disposed on one surface of the tantalum body 100 to form a withdrawal structure as a cathode terminal (a second external electrode).

The withdrawal layer 400 may connect the second external electrode 520 and the tantalum body 100 to each other, and at least a portion of the withdrawal layer 400 may be disposed in the recess portion R.

In the tantalum capacitor according to the related art, when a withdrawal layer 400 is formed on one surface of a tantalum body 100, the withdrawal layer 400 may be formed in a direction that is difficult to predict, depending on the viscosity of the withdrawal layer. In particular, when the withdrawal layer is exposed to the exterior of a tantalum component, an exposure defect may occur, affecting component reliability.

Accordingly, in the tantalum capacitor 1000 according to an example embodiment of the present disclosure, a portion of the withdrawal layer may be disposed in the recess portion R.

Referring to FIGS. 3 and 4, a portion of the withdrawal layer 400 may be disposed in the recess portion R and, specifically, may be disposed between the side surface 322 of the recess portion R and one surface of the tantalum body 100.

The withdrawal layer 400 may be disposed between the inclined surface 323 of the recess portion R and one surface of the tantalum body 100.

The withdrawal layer 400 may be in contact with the bottom surface 321 of the recess portion R. In addition, the withdrawal layer 400 may be in contact with the side surface 322 and the inclined surface 323 of the recess portion R.

As described above, at least a portion of the withdrawal layer 400 may be disposed in the recess portion R to prevent an overflow phenomenon when the withdrawal layer 400 is formed, and the withdrawal layer 400 may be uniformly formed on one surface of the tantalum body 100. Accordingly, the tantalum body 100 may have improved connection reliability with the external electrode 520.

The withdrawal layer 400 may include silver (Ag), palladium (Pd), gold (Au), nickel (Ni), copper (Cu), or the like, and may be formed of viscous conductive paste.

The withdrawal layer 400 may be formed on one surface of the tantalum body 100 using a method such as dispensing, dipping, printing, or the like, but the present disclosure is not limited thereto.

While the example embodiments have been shown and described above, it will be apparent to those skilled in the art that modifications and variations could be made without departing from the scope of the present disclosure as defined by the appended claims.

What is claimed is:

1. A tantalum capacitor comprising:
an insulating material having one surface in which a recess portion having a bottom surface lower than the one surface is formed;
a tantalum body disposed on the bottom surface, the tantalum body comprising a tantalum element body, and a tantalum wire passing through at least a portion of the tantalum element body in a first direction;
a molded portion having a fifth surface and a sixth surface opposing each other in the first direction, a third surface and a fourth surface opposing each other in a second direction, a first surface and a second surface opposing each other in a third direction, the molded portion formed to surround the tantalum body; and
first and second external electrodes connected to the tantalum body, wherein the first and second external electrodes are spaced apart from each other in the first direction.

2. The tantalum capacitor of claim 1, wherein an upper surface of the tantalum body is higher than the one surface of the insulating material.

3. The tantalum capacitor of claim 1, wherein
the recess portion further has a side surface connecting the one surface of the insulating material to the bottom surface, and
the side surface is spaced apart from the tantalum body.

4. The tantalum capacitor of claim 1, wherein
the recess portion further has an inclined surface connecting the one surface of the insulating material to the bottom surface, and
the inclined surface has an inclination angle relative to the one surface.

5. The tantalum capacitor of claim 4, wherein the inclined surface is spaced apart from the tantalum body.

6. The tantalum capacitor of claim 1, further comprising:
a withdrawal layer connecting the first external electrode and the tantalum body to each other, the withdrawal layer having at least a portion disposed on the recess portion.

7. The tantalum capacitor of claim 6, wherein the withdrawal layer is in contact with the bottom surface of the recess portion.

8. The tantalum capacitor of claim 1, wherein the second external electrode is connected to the tantalum wire.

9. The tantalum capacitor of claim 1, wherein the first and second external electrodes extend to another surface opposing the one surface of the insulating material.

10. The tantalum capacitor of claim 1, wherein
the insulating material includes a protrusion portion, protruding from the one surface, on the one surface, and
the protrusion portion supports the tantalum wire.

11. The tantalum capacitor of claim 1, wherein the insulating material and the molded portion include the same material.

12. A tantalum capacitor comprising:
an insulating material having one surface on which a protrusion portion, protruding from the one surface, is formed;
a tantalum body disposed on the insulating material, the tantalum body comprising a tantalum element body, and a tantalum wire passing through at least a portion of the tantalum element body in a first direction;
a molded portion having a fifth surface and a sixth surface opposing each other in the first direction, a third surface and a fourth surface opposing each other in a second direction, a first surface and a second surface opposing each other in a third direction, the molded portion formed to surround the tantalum body; and
first and second external electrodes connected to the tantalum body, wherein the first and second external electrodes are spaced apart from each other in the first direction,
wherein the protrusion portion of the insulating material supports the tantalum wire.

13. The tantalum capacitor of claim 12, wherein
a groove is formed in the protrusion portion, and
the tantalum wire is connected to the groove.

14. The tantalum capacitor of claim 12, wherein the protrusion portion is spaced apart from the first and second external electrodes.

15. The tantalum capacitor of claim 12, wherein the first and second external electrodes extend to another surface opposing the one surface of the insulating material.

16. A tantalum capacitor comprising:
an insulating material having a recess portion formed on one surface thereof, the recess portion having a bottom surface lower than the one surface, and a side surface connecting the bottom surface to the one surface;
a tantalum body disposed on the bottom surface of the recess portion;
a molded portion formed to surround the tantalum body and covering the tantalum body, the molded portion comprising a first surface, a second surface opposing the first surface in a first direction, a third surface, and a fourth surface opposing the third surface in a second direction different from the first direction;
a withdrawal layer disposed on a portion of the tantalum body and at least partially disposed within the recess portion, the withdrawal layer being in contact with the bottom surface of the recess portion and extending along the side surface of the recess portion, the withdrawal layer connecting the tantalum body to a second external electrode;
first and second external electrodes are connected to the tantalum body and spaced apart from each other in the first direction.

17. The tantalum capacitor of claim 16, wherein the withdrawal layer includes a viscous conductive paste comprising at least one material selected from the group consisting of silver (Ag), palladium (Pd), gold (Au), nickel (Ni), and copper (Cu).

18. The tantalum capacitor of claim 16, wherein the molded portion is formed by transfer-molding a resin, the resin comprising an epoxy molding compound (EMC).
